(19) United States
(12) Patent Application Publication
(10) Pub. No.: US 2017/0328062 A1
(43) Pub. Date: Nov. 16, 2017

(54) CONSTRUCTION BOARDS WITH COATED FACERS

(71) Applicant: FIRESTONE BUILDING PRODUCTS CO., LLC, Nashville, TN (US)

(72) Inventors: John B. LETTS, Carmel, IN (US); Michael VALL, Carmel, IN (US); Timothy L. BERGWALL, Dublin, OH (US)

(73) Assignee: FIRESTONE BUILDING PRODUCTS CO., LLC, Nashville, TN (US)

(21) Appl. No.: 15/667,811

(22) Filed: Aug. 3, 2017

Related U.S. Application Data
(63) Continuation of application No. 14/966,044, filed on Dec. 11, 2015.
Application No. 14/966,044 is a continuation of application No. 13/640,921, filed on Mar. 6, 2013, now abandoned.
(60) Provisional application No. 61/324,064, filed on Apr. 14, 2010.

(51) Int. Cl. E04C 2/24; B32B 23/08; E04C 2/296

(52) U.S. Cl. CPC E04C 2/24; E04C 2/296; B32B 23/08; B32B 2255/02; B32B 2307/7246; B32B 2255/26

(57) ABSTRACT

A construction board comprising of a foam body, said foam body having first and second planar sides; and a facer affixed to said first or second planar surface, said facer including a cellulosic substrate and a water-resistant coating layer, said cellulosic layer having first and second planar sides, where said first planar side of said cellulosic substrate is affixed to said foam body and said second planar side carries said coating, where said cellulosic substrate is substantially devoid of fiberglass, where said water-resistant coating layer has a thickness of less than 1.5 mm, and where said water-resistant coating layer includes a polymeric binder and a filler dispersed throughout the binder.

This application is a continuation of U.S. application Ser. No. 14/966,044 filed on Dec. 11, 2015, and U.S. National Stage application Ser. No. 13/640,921 filing dated Mar. 6, 2013, which invention claims the priority of International Application Serial No. PCT/US2011/032461 filed on Apr. 14, 2011, and claims the benefit of U.S. Provisional Application Ser. No. 61/324,064 filed on Apr. 14, 2010, which are incorporated herein by reference.

### FIELD OF THE INVENTION

One or more embodiments of the present invention relate to construction boards with particular facers that yield advantageous properties to the construction boards.

### BACKGROUND OF THE INVENTION

Construction boards, particularly those employed in the construction industry, may include a foam layer and at least one facer. Often, the foam layer is sandwiched between two facers. The foam layer can include a closed cell polyurethane or polyisocyanurate foam.

The facer materials can impact the ultimate performance of the construction boards. This is particularly true where the construction boards include roofing insulation boards or roofing recover boards that must meet various performance specifications.

Numerous facer materials have been employed; for example, the art teaches cellulosic, foil, and fiberglass facers. Many facers commercially employed in roofing construction boards include various recycled cellulosic materials. Inasmuch as the quality of these cellulosic materials may be suspect, conventional practice includes combining the cellulosic material with fiberglass in an effort to improve the performance of the facer with construction boards.

One commonly used facer includes approximately 85% recycled cellulose fibers (paper/paperboard) and 15% chopped fiberglass. Minor amounts of papermaking additives and coloring may also be used in the production of conventional facers. The use of chopped fiberglass, however, can have many drawbacks. There is, therefore, a desire to remove or reduce the amount of fiberglass that exists within these facers.

### SUMMARY OF THE INVENTION

Embodiments of the present invention provide a construction board comprising of a foam body, said foam body having first and second planar sides; and a facer affixed to said first or second planar surface, said facer including a cellulosic substrate and a water-resistant coating layer, said cellulosic layer having first and second planar sides, where said first planar side of said cellulosic substrate is affixed to said foam body and said second planar side carries said coating, where said cellulosic substrate is substantially devoid of fiberglass, where said water-resistant coating layer has a thickness of less than 1.5 mm, and where said water-resistant coating layer includes a polymeric binder and a filler dispersed throughout the binder.

Other embodiments of the present invention provide a foam composite comprising of a foam body having first and second planar surfaces; a cellulosic substrate, said cellulosic substrate having first and second planar surfaces, where said first planar surface of said cellulosic substrate is affixed to said first planar surface of said foam body, said cellulosic substrate being characterized by a density of at least 500 kg/m3, a thickness of from about 5 mils to about 12 mils, a basis weight of at least 35, and including less than 1% weight percent non-cellulosic materials; and a layer of water-resistant polymer layer disposed on said second planar surface of said cellulosic substrate, where said water-resistant polymer layer has a thickness of less than 1.5 mm.

Still other embodiments of the present invention provide A method for preparing a foam composite, the method comprising of providing cellulosic substrate having first and second planar surfaces, where the first planar surfaces carries a water-repellant polymeric coating having a thickness of less than 1.5 mm, where said cellulosic substrate is characterized by a density of at least 500 kg/m3, a thickness of from about 5 mils to about 12 mils, a basis weight of at least 35, and is substantially devoid of fiberglass; where said second planar surface is substantially devoid of said water-repellant polymeric coating; mixing an isocyanate with a polyol to form a developing foam mixture; depositing the developing foam mixture on said second planar surface of said cellulosic substrate; and heating the combination of developing foam mixture and cellulosic substrate to form the foam composite.

### BRIEF DESCRIPTION OF THE DRAWINGS

FIG. 1 is a perspective view of a construction board of one or more embodiments of the present invention.

FIG. 2 is a fragmentary side profile view of a construction board of one or more embodiments of the present invention, and shows a coated facer having a barrier coating.

### DETAILED DESCRIPTION OF ILLUSTRATIVE EMBODIMENTS

Embodiments of the present invention are based, at least in part, on the discovery of a construction board including a foam layer and at least one cellulosic facer having a water-resistant coating. While advantages have been derived from construction boards that employ facers that only include cellulosic fibers, it has been observed that these construction boards tend to curl or bow when subjected to a difference in moisture on one side of the board relative to the other side. For example, if a construction board is laid flat in a parking lot and dew settles or rain falls on the sky-facing facer, the edges and corners of the construction board will bow toward the sky as the construction board dries. It has now been discovered that benefits of a cellulosic facer can be realized while avoiding or minimizing curling or bowing issues by employing a facer that includes a water-resistant coating. In particular embodiments, the construction boards of this invention are useful as insulation boards for flat or low-sloped roofing systems. In other embodiments, the construction boards of this invention are useful as cover or re-cover boards for flat or low-sloped roofing systems.

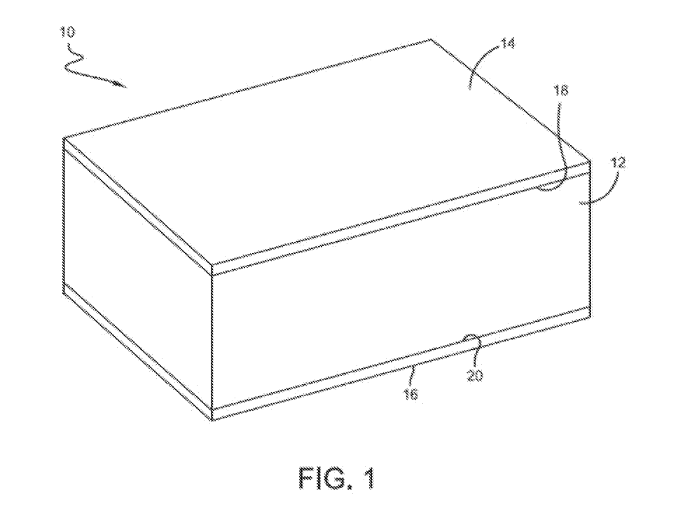

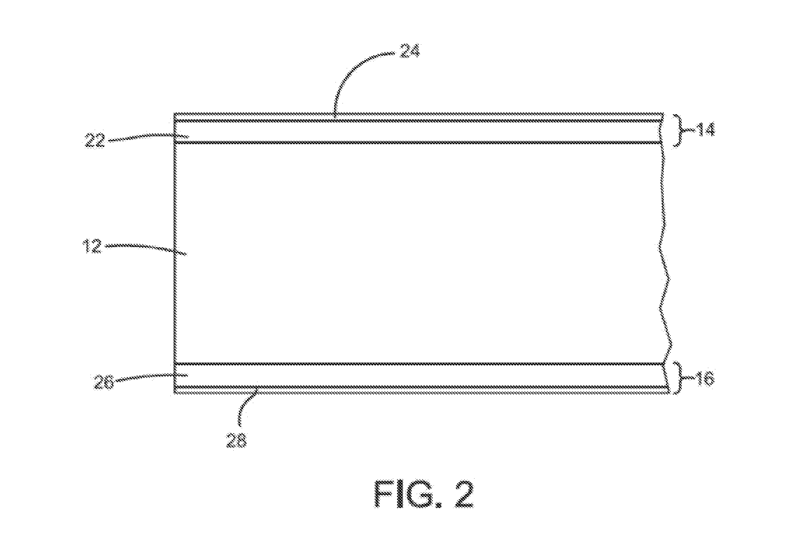

Construction boards of one or more embodiments of the present invention may be described with reference to FIGS. 1 and 2. FIG. 1 shows a construction board that is indicated generally by the numeral 10. Construction board 10 includes a foam layer 12 sandwiched between first facer 14 and optional second facer 16. Facers 14 and 16 are attached to foam layer 12 at first planar surface 18 and second planar surface 20, respectively, of foam layer 12. In one or more embodiments, facer 14 (and optionally facer 16) are continuous over the entire planar surface 18 (or planar surface 20). In these or other embodiments, facer 14 (and optionally facer 16) are discontinuous; for example, the facers may be perforated so as to allow fluid or gaseous communication between the foam and the environment.

As shown in FIG. 2, coated facer 14 includes a cellulosic substrate 22 having coating 24. Coating 24 is situated on the side of cellulosic substrate 22 opposite foam layer 12. Second facer 16 can also include a cellulosic substrate 26 having a coating 28. Coating 28 is situated on the side of the cellulosic substrate opposite foam layer 12 (not shown).

In one or more embodiments, foam layer 12 includes a rigid closed-cell foam structure. In one or more embodiments, foam layer 12 may include a polyurethane or polyisocyanurate foam. Foam layer 12 may include other constituents, such as flame retardants, as is generally known in the art.

In one or more embodiments, foam layer 12 may be characterized by a foam density (ASTM C303) that is less than 2.5 pounds per cubic foot (12 kg/m²), in other embodiments less than 2.0 pounds per cubic foot (9.8 kg/m²), in other embodiments less than 1.9 pounds per cubic foot (9.3 kg/m²), and still in other embodiments less than 1.8 pounds per cubic foot (8.8 kg/m²). In one or more embodiments, the foam layer 12 of insulation boards is characterized by having a density that is greater than 1.50 pounds per cubic foot (7.32 kg/m²), or in other embodiments, greater than 1.55 pounds per cubic foot (7.57 kg/m²).

Where the density of foam layer 12 is less than 2.5 pounds per cubic foot, it may be advantageous for foam layer 12 to be characterized by having an index of at least 120, in other embodiments at least 150, in other embodiments at least 175, in other embodiments at least 200, and in other embodiments at least 225, as determined by PIR/PUR ratio as determined by IR spectroscopy using standard foams of known index (note that ratio of 3 PIR/PUR provides an ISO Index of 300). Foam construction boards having a foam layer of similar nature are described in U.S. Pat. Nos. 6,117,375, 6,044,604, 5,891,563, 5,573,092, U.S. Publication Nos. 2004/0109983, 2003/0082365, 2003/0153656, 2003/0032351, and 2002/0013379, as well as U.S. Ser. Nos. 10/640,895, 10/925,654, and 10/632,343, which are incorporated herein by reference.

In other embodiments, foam layer 12 may be characterized by density that is greater than 2.5 pounds per cubic foot (12.2 kg/m²), as determined according to ASTM C303, in other embodiments the density is greater than 2.8 pounds per cubic foot (13.7 kg/m²), in other embodiments greater than 3.0 pounds per cubic foot (14.6 kg/m²), and still in other embodiments greater than 3.5 pounds per cubic foot (17.1 kg/m²). In one or more embodiments, the density of foam layer 12 of the recovery boards may be less than 20 pounds per cubic foot (97.6 kg/m²), in other embodiments less than 10 pounds per cubic foot (48.8 kg/m²), in other embodiments less than 6 pounds per cubic foot (29.3 kg/m²), in other embodiments less than 5.9 pounds per cubic foot (28.8 kg/m²), in other embodiments less than 5.8 pounds per cubic foot (28.3 kg/m²), in other embodiments less than 5.7 pounds per cubic foot (27.8 kg/m²), in other embodiments less than 5.6 pounds per cubic foot (27.3 kg/m²), and still in other embodiments less than 5.5 pounds per cubic foot (26.9 kg/m²). Foam construction boards having a foam layer of similar nature are described in U.S. application Ser. Nos. 11/343,466 and 12/525,159, which are incorporated herein by reference.

Where the density of foam layer 12 is greater than 2.5 pounds per cubic foot, it may be advantageous for foam layer 12 to be characterized by an ISO Index, as determined by PIR/PUR ratio as determined by IR spectroscopy using standard foams of known index (note that ratio of 3 PIR/PUR provides an ISO Index of 300) of at least 180, in other embodiments at least 200, in other embodiments at least 220, in other embodiments at least 270, in other embodiments at least 285, in other embodiments at least 300, in other embodiments at least 315, and in other embodiments at least 325. In these or other embodiments, the ISO Index may be less than 360, in other embodiments less than 350, in other embodiments less than 340, and in other embodiments less than 335.

In one or more embodiments, cellulosic substrate 22 of facer 14 (and optionally optional facer 16) includes cellulose fibers, which may also be referred to as pulp. These fibers may derive from wood, fibre crops, or waste paper. Wood fibers, also referred to as pulpwood, may derive from softwood trees such as spruce, pine, fir, larch, and hemlock, or from hardwoods such as eucalyptus, aspen and birch. As is known in the art, pulp can be obtained by mechanical, chemical, thermo-mechanical, or recycle pulping processes. In particular embodiments, the pulp is obtained from kraft processing. In these or other embodiments, the pulp is de-inkend or recycled pulp. In particular embodiments, the pulp may be bleached. In other embodiments, the pulp is un-bleached.

In one or more embodiments, cellulosic substrate 22 (apart from any coating that may be applied thereto) may be characterized by a density of at least 400 kg/m³, in other embodiments at least, 500 kg/m³, in other embodiments at least 750 kg/m³, in other embodiments at least 1000 kg/m³, in other embodiments at least 1250 kg/m³, and in other embodiments at least 1500 kg/m³.

In one or more embodiments, cellulosic substrate 22 (apart from any coating that may be applied thereto) may be characterized by a thickness of at least about 5 mils (0.12 mm), in other embodiments at least about 7 mils (0.17 mm), and in other embodiments at least about 10 mils (0.25 mm). In these or other embodiments, the cellulose fiber substrate 22 of the at least one facer has a thickness of less than about 25 mils, in other embodiments less than about 20 mils (0.5 mm), in other embodiments less than about 18 mils (0.45 mm), and in other embodiments less than about 12 mils (0.3 mm).

In one or more embodiments, cellulosic substrate 22 may have a basis weight of at least 25, in other embodiments at least 35, in other embodiments at least 45, in other embodiments at least 55, and in other embodiments at least 65 pounds per 1000 square feet. In these or other embodiments, the basis weight of cellulosic substrate 22 is essentially consistent across the planar surface of the construction board.

In one or more embodiments, the cellulosic substrate 22 is free of or only includes limited amounts of non-cellulosic materials (e.g. fiberglass). For example, in certain embodiments, cellulosic substrate 22 includes less than 15% by weight, in other embodiments less than 10% by weight, in other embodiments less than 5% by weight, and in other embodiments less than 1% by weight fiberglass based on the entire weight of cellulosic substrate 22. In particular embodiments, the cellulosic substrate 22 is substantially devoid of fiberglass, which includes an amount less than would otherwise have an appreciable impact on the facer and/or construction board. In one or more embodiments, the at least one cellulosic substrate 22 of the construction boards is devoid of fiberglass.

In particular embodiments, cellulosic substrate 22 is characterized by a burst strength, pursuant to T403 om-02 (TAPPI), as measured apart from the construction boards, of at least 150 kPa, in other embodiments at least 250 kPa, in other embodiments at least 350 kPa, in other embodiments at least 450 kPa, in other embodiments at least 520 kPa, in other embodiments at least 600 kPa, and in other embodiments at least 650 kPa. In these or other embodiments, the burst strength is less than 1,500 kPa, in other embodiments less than 1,000 kPa, and in other embodiments less than 850 kPa.

In particular embodiments, cellulosic substrate 22 is characterized by a machine direction tensile strength, pursuant to T494 om-01 (TAPPI), as measured apart from the construction board, of at least 7.5 kn/m, in other embodiments at least 8.5 kn/m, in other embodiments at least 10.0 kn/m, in other embodiments at least 11.0 kn/m, in other embodiments at least 12.0 kn/m, and in other embodiments at least 15.0 kn/m.

In one or more embodiments, cellulosic substrate 22 includes cellulosic fibers that derive from conifers. In these or other embodiments, cellulosic substrate 22 may include cellulosic fibers that derive from southern pines. In particular embodiments, the cellulosic fibers are fibrillated. These cellulosic fibers may advantageously derive from virgin pulp, as well as recycled materials. These recycled materials may include old corrugated containers, mixed office waste, and old newspapers.

In one or more embodiments, the cellulosic fibers employed in the cellulosic substrate 22 of the facer of the present invention include fiber characterized by a relatively long length, especially as compared to cellulosic fibers conventionally employed in the art of making facers for insulation board. In one or more embodiments, the fibers employed in the present invention are at least 5% greater, in other embodiments at least 10% greater, in other embodiments at least 20% greater, in other embodiments at least 40% greater, and in other embodiments at least 80% greater in length than the length of fiber in conventional cellulosic materials (e.g. recycled cellulosic materials) conventionally employed in the art.

In one or more embodiments, the cellulosic substrate 22 may also include other ingredients conventionally found in facers of construction boards. For example, the cellulosic substrate 22 may include pigments, mold inhibiting agents, filler, and/or flame retardants.

In one or more embodiments, coating 24 (and optionally optional coating 28) may include a water-repellant coating, which may also be referred to as a hydrophobic coating. In particular embodiments, water-repellant coating 24 is insoluble in water. In these or other embodiments, water-repellent coating 24 inhibits the transfer of water though the coating and into cellulosic substrate 22 (e.g. coating 24 is impervious to water).

In one or more embodiments, coating 24 includes a binder or matrix and optionally filler or other constituents dispersed throughout the binder. The binder may include natural or synthetic materials. For example, natural materials may include natural rubber, waxes and starches. Synthetic materials may include polyolefins, styrene-butadiene latexes, polyvinyl chlorides, acrylic latexes, and methacrylic latexes, silicones, as well as functional copolymers thereof. For example, the binders may include styrene-butadiene latexes bearing one or more hydrophobic moieties (e.g. fluorine-containing groups) for repelling water.

In one or more embodiments, coating 24 is applied to cellulosic substrate 22 by employing conventional paper coating techniques. For example, coating 24 may be applied by gravure coating, reverse roll coating, slot die coating, immersion (dip) coating, knife coating, electrohydrodynamic spraying, and the like.

In one or more embodiments, coating 24 may have a thickness of at least 0.005 mm, in other embodiments at least 0.01 mm, in other embodiments 0.05 mm, and in other embodiments at least 0.09 mm. In these or other embodiments, coating 24 may have a thickness of less than 1.5 mm, in other embodiments less than 1.0 mm, in other embodiments less than 0.7 mm, in other embodiments less than 0.3 mm, and in other embodiments less than 0.1 mm.

The construction boards of one or more embodiments may be prepared by employing conventional techniques such as those that include a laminator. As is generally known in the art, the facer is positioned onto a laminator, and a foam-forming material is subsequently deposited onto the facer. In those embodiments where the foam-forming material is deposited onto a coated facer, the foam-forming material is deposited onto the side of the coated facer that does not include the coating. In other words, the foam-forming material is applied to the side of the facer that is opposite to the side of the facer where the coating was applied. Where an additional facer is incorporated into the construction board, the additional facer may be positioned and ultimately contacted with the rising foam product. In one or more embodiments, the facer is preheated prior to being contacted with the foam or foam-forming material. In one or more embodiments, the facer is preheated to a temperature of at least 90° F. (32° C.), in other embodiments at least 100° F. (37° C.), and in other embodiments at least 110° F. (43° C.). In these or other embodiments, the facer is preheated to a temperature of less than 140° C., in other embodiments less than, 130° C., and in other embodiments less than 120° C.

The boards of one or more embodiments of this invention can be manufactured by using known techniques for producing polyurethane or polyisocyanurate insulation. In general, processes for the manufacture of polyurethane or polyisocyanurate insulation boards are known in the art as described in U.S. Pat. Nos. 6,117,375, 6,044,604, 5,891,563, 5,573,092, U.S. Publication Nos. 2004/0109983, 2003/0082365, 2003/0153656, 2003/0032351, and 2002/0013379, as well as U.S. Ser. Nos. 10/640,895, 10/925,654, and 10/632,343, which are incorporated herein by reference.

In one or more embodiments, the construction boards of the present invention may be produced by developing or forming polyurethane and/or polyisocyanurate foam in the presence of a blowing agent. The foam may be prepared by contacting an A-side stream of reagents with a B-side stream of reagents and depositing the mixture or developing foam onto a laminator carrying a facer. The A-side stream may include an isocyanate compound and the B-side may include an isocyanate-reactive compound.

In one or more embodiments, the A-side stream may only contain the isocyanate. In other embodiments, the A-side stream may also contain flame-retardants, surfactants, blowing agents and other non-isocyanate-reactive components.

Suitable isocyanates are generally known in the art. Useful isocyanates include aromatic polyisocyanates such as diphenyl methane, diisocyanate in the form of its 2,4′-, 2,2′-, and 4,4′-isomers and mixtures thereof, the mixtures of diphenyl methane diisocyanates (MDI) and oligomers thereof known in the art as “crude” or polymeric MDI having an isocyanate functionality of greater than 2, toluene diisocyanate in the form of its 2,4′ and 2,6′-isomers and mixtures thereof, 1,5-naphthalene diisocyanate, and 1,4′ diisocyanatobenzene. Exemplary isocyanate components include polymeric Rubinate 1850 (Huntsmen Polyurethanes), polymeric Lupranate M70R (BASF), and polymeric Mondur 489N (Bayer).

The B-side stream, which contains isocyanate reactive compounds, may also include flame retardants, catalysts, emulsifiers/solubilizers, surfactants, blowing agents, fillers, fungicides, anti-static substances, water and other ingredients that are conventional in the art.

An exemplary isocyanate-reactive component is a polyol. The terms polyol or polyol component include diols, polyols, and glycols, which may contain water as generally known in the art. Primary and secondary amines are suitable, as are polyether polyols and polyester polyols. Useful polyester polyols include phthalic anhydride based PS-2352 (Stepen), phthalic anhydride based polyol PS-2412 (Stepen), teraphthalic based polyol 3522 (Kosa), and a blended polyol TR 564 (Oxid). Useful polyether polyols include those based on sucrose, glycerin, and toluene diamine. Examples of glycols include diethylene glycol, dipropylene glycol, and ethylene glycol. Suitable primary and secondary amines include, without limitation, ethylene diamine, and diethanolamine. In one embodiment a polyester polyol is employed. In one or more embodiments, the present invention may be practiced in the appreciable absence of any polyether polyol. In certain embodiments, the ingredients are devoid of polyether polyols.

Catalysts are believed to initiate the polymerization reaction between the isocyanate and the polyol, as well as a trimerization reaction between free isocyanate groups when polyisocyanurate foam is desired. While some catalysts expedite both reactions, two or more catalysts may be employed to achieve both reactions. Useful catalysts include salts of alkali metals and carboxylic acids or phenols, such as, for example potassium octoate; mononuclear or polynuclear Mannich bases of condensable phenols, oxo-compounds, and secondary amines, which are optionally substituted with alkyl groups, aryl groups, or aralkyl groups; tertiary amines, such as pentamethyldiethylene triamine (PMDETA), 2,4,6-tris [(dimethylamino)methyl]phenol, triethyl amine, tributyl amine, N-methyl morpholine, and N-ethyl morpholine; basic nitrogen compounds, such as tetra alkyl ammonium hydroxides, alkali metal hydroxides, alkali metal phenolates, and alkali metal acholates; and organic metal compounds, such as tin(II)-salts of carboxylic acids, tin(IV)-compounds, and organo lead compounds, such as lead naphthenate and lead octoate.

Surfactants, emulsifiers, and/or solubilizers may also be employed in the production of polyurethane and polyisocyanurate foams in order to increase the compatibility of the blowing agents with the isocyanate and polyol components.

Surfactants may serve two purposes. First, they may help to emulsify/solubilize all the components so that they react completely. Second, they may promote cell nucleation and cell stabilization. Exemplary surfactants include silicone co-polymers or organic polymers bonded to a silicone polymer. Although surfactants can serve both functions, a more cost effective method to ensure emulsification/solubilization may be to use enough emulsifiers/solubilizers to maintain emulsification/solubilization and a minimal amount of the surfactant to obtain good cell nucleation and cell stabilization. Examples of surfactants include Pelron surfactant 9920, Goldschmidt surfactant 58522, and GE 6912. U.S. Pat. Nos. 5,686,499 and 5,837,742 are incorporated herein by reference to show various useful surfactants.

Suitable emulsifiers/solubilizers include DABCO Ketene 20AS (Air Products), and Tergitol NP-9 (nonylphenol+9 moles ethylene oxide).

Flame Retardants may be used in the production of polyurethane and polyisocyanurate foams, especially when the foams contain flammable blowing agents such as pentane isomers. Useful flame retardants include tri(monochloropropyl) phosphate (a.k.a. tris(cloro-propyl) phosphate), tri-2-chloroethyl phosphate (a.k.a tris(chloro-ethyl) phosphate), phosphonic acid, methyl ester, dimethyl ester, and diethyl ester. U.S. Pat. No. 5,182,309 is incorporated herein by reference to show useful blowing agents. Useful blowing agents include isopentane, n-pentane, cyclopentane, alkanes, (cyclo)alkanes, hydrofluorocarbons, hydrochlorofluorocarbons, fluorocarbons, fluorinated ethers, alkenes, alkynes, carbon dioxide, and noble gases.

In one or more embodiments, the construction boards of this invention may be employed as insulation boards within flat or low-sloped roofing systems. In these embodiments, it may be advantageous to employ those boards characterized by a density of less than 2.5 pounds per cubic foot. In other embodiments, the construction boards of this invention may be employed as cover or re-cover boards within flat or low-sloped roofing systems. In these embodiments, it may be advantageous to employ those boards characterized by a density of greater than 2.5 pounds per cubic foot.

In one or more embodiments, the construction boards of the present invention have several advantages over prior art forms. For example, the boards of one or more embodiments are dimensionally stable with respect to moisture. The barrier coating of one or more embodiments prevents moisture from being absorbed by the cellulose fiber substrate of the coated facer, and therefore the curling or bowing that characterized prior art forms has been eliminated, or at least significantly reduced. Also, the construction boards of one or more embodiments of the present invention may be manufactured without using chopped fiberglass. Fiberglass-free construction boards are less susceptible to static electricity that can lead to sparks and increase fire hazards, especially in low humidity environments. Fiberglass-free construction boards may weigh less than construction boards that include fiberglass. And fiberglass-free construction boards can be recycled within a conventional paper/paperboard recycling process, whereas construction boards that include fiberglass cannot.

Thus, it can be seen that the objects of the invention have been satisfied by the structure and its method of manufacture presented above. While in accordance with the Patent Statutes, only the best mode and preferred embodiment have been presented and described in detail, it is to be understood that the invention is not limited thereto or thereby. Accordingly, for an appreciation of the true scope and breadth of the invention, reference should be made to the following claims.

1. A construction board comprising:
(i) a foam body, said foam body having first and second planar sides; and
(ii) a facer affixed to said first or second planar surface, said facer including a cellulosic substrate and a water-resistant coating layer, said cellulosic substrate having first and second planar sides, where said first planar side of said cellulosic substrate is affixed to said foam body and said second planar side carries said coating, where said cellulosic substrate contains less than 5% by weight of fiberglass based on the entire weight of said cellulosic substrate, where said water-resistant coating layer has a thickness of less than 1.5 mm, and where said water-resistant coating layer includes a polymeric binder and a filler dispersed throughout the binder.

2. The construction board of claim 1, where said foam body is characterized by a foam density of less than 2.5 pounds per cubic foot.

3. The construction board of claim 2, where the foam body is characterized by an ISO index of at least 180.

4. The construction board of claim 1, where said foam body is characterized by a foam density of greater than 2.5 pounds per cubic foot.

5. The construction board of claim 4, where the foam body is characterized by an ISO index of at least 220.

6. The construction board of claim 1, where the cellulosic substrate is devoid of fiberglass.

7. The construction board of claim 1, where the water-resistant coating layer includes a synthetic latex as a binder.

8. The construction board of claim 1, where the water-resistant coating layer has a thickness of less than 1.0 mm.

9. The construction board of claim 1, where the water-resistant coating layer has a thickness of less than 0.7 mm.

10. The construction board of claim 9, where the cellulosic substrate is characterized by a density of at least 400 kg/m³, a thickness of at least 5 mils and less than 25 mils, and a basis weight of at least 45 pounds per 1000 square feet.

11. A foam composite comprising:
(i) a foam body having first and second planar surfaces;
(ii) a cellulosic substrate, said cellulosic substrate having first and second planar surfaces, where said first planar surface of said cellulosic substrate is affixed to said first planar surface of said foam body, said cellulosic substrate being characterized by a density of at least 500 kg/m³, a thickness of from about 5 mils to about 12 mils, a basis weight of at least 35 pounds per 1000 square feet, and including less than 1% weight percent non-cellulosic materials; and
(iii) a layer of water-resistant polymer disposed on said second planar surface of said cellulosic substrate, where said water-resistant polymer layer has a thickness of less than 1.5 mm.

12. The foam composite of claim 11, where said water-resistant polymer layer has a thickness of less than 0.7 mm.

13. The foam composite of claim 11, where said water-resistant polymer layer includes a latex.

14. The foam composite of claim 11, where the cellulosic substrate is characterized by a density of at least 750 kg/m³, a thickness of from about 7 mils to about 10 mils, and is substantially devoid of fiberglass.

15. The foam composite of claim 11, where the cellulosic substrate is characterized by a burst strength of at least 150 kPa, and a machine direction tensile strength of at least 7.5 kn/m.

16. The foam composite of claim 15, where the cellulosic substrate includes cellulosic fibers that derive from conifers.

17. A method for preparing a foam composite, the method comprising:
(i) providing cellulosic substrate having first and second planar surfaces, where the first planar surfaces carries a water-repellant polymeric coating having a thickness of less than 1.5 mm, where said cellulosic substrate is characterized by a density of at least 500 kg/m³, a thickness of from about 5 mils to about 12 mils, a basis weight of at least 35 pounds per 1000 square feet, and is substantially devoid of fiberglass; where said second planar surface is substantially devoid of said water-repellant polymeric coating;
(ii) mixing an isocyanate with a polyol to form a developing foam mixture;
(iii) depositing the developing foam mixture on said second planar surface of said cellulosic substrate; and
(iv) heating the combination of developing foam mixture and cellulosic substrate to form the foam composite.

18. The method of claim 17, where said step of heating takes place within a laminator.

19. The construction board of claim 1, where the board, when exposed to water, displays minimal or no bowing or curling upon drying.
